(19) United States
(12) Patent Application Publication
(10) Pub. No.: US 2002/0027679 A1
(43) Pub. Date: Mar. 7, 2002

(54) Optical polarization method and apparatus

(76) Inventors: Milan M. Popovich, Leicester (GB); Stephen F. Sagan, Sierra Madre, CA (US)

Correspondence Address: Robert C. Strawbrich, SKJERVEN MORRILL MacPHERSON LLP, Suite 700, 25 Metro Drive, San Jose, CA, 95110-1349, US

(21) Appl. No.: 09/747,339

(22) Filed: Dec. 22, 2000

Related U.S. Application Data
(60) Provisional application No. 60/171,788, filed on Dec. 22, 1999.
(60) Provisional application No. 60/166,963, filed on Nov. 23, 1999.

(51) Int. Cl. G03H 1/02; G03H 1/28; G02B 5/30; G02B 5/32; G02B 27/28

(52) U.S. Cl. 359/15; 359/3; 359/7; 359/24; 359/495

(57) ABSTRACT

An optical polarization apparatus for application to color displays for laptop computers and hand held computers, and other applications where it is advantageous to switchably control the polarization of monochromatic light. In a first preferred embodiment, the apparatus includes a first holographic optical device disposed between a source of randomly polarized light and a second holographic optical device that produces an output beam of plane-polarized light in a desired direction. The first optical device is a Bragg hologram that characteristically diffracts p-polarized light significantly more efficiently than s-polarized light. The first device splits the randomly polarized light into these two orthogonal components. The second device contains two alternating regions of holograms, one which is designed to further diffract the p-polarized light to attain the desired output direction, and the other to rotate the polarization of the s-polarized light to attain p-polarized light, which is then also diffracted to produce the desired output direction. Thus, the output is wholly p-polarized. In one embodiment, the holograms in the two devices are designed to diffract only one range of monochromatic light. In another, multiple hologram elements are stacked to achieve polarization of a wider bandwidth light. The holograms are switchable such that only one hologram element in each device is active at any time. In another embodiment, the holograms are reversed to achieve an output that is virtually entirely s-polarized light. Finally, a collimator is employed between the randomly polarized light and the first device as either a lens, an array of lenses or as a hologram integral with the first device.

### RELATED APPLICATIONS

This application claims priority from the provisional application 60/171,788 filed Dec. 22, 1999.

### BACKGROUND OF THE INVENTION

1. Field of the Invention

This invention relates to an optical polarization device, and more particularly to an optical polarization device employing switchable holographic diffraction devices.

2. Description of the Related Art

There are many commercial applications that benefit from the process of polarizing light. For example, certain displays such as projection displays, which use reflective Liquid Crystal micro-display panels as the input image source, must be illuminated with polarized light. The ability to convert light from a randomly polarized source into linearly polarized light therefore translates into a brighter output image for a given light source power. Thus, it would also be advantageous to programmably control the color of the light that is polarized by such devices and materials for such applications.

Prior art polarization converters simply absorb light of the unwanted planer polarization. Unfortunately, this solution wastes at least 50% of the available input light. Known alternative methods of polarization that recover the lost light by conversion of the unwanted polarization to a desired polarization plane typically rely on optical configurations based on polarizing beam splitter cubes combined with half wave plates for rotating either the s or p polarization and a mirror for redirecting the beams into the same direction. Such solutions are large, heavy and expensive. One implementation of the foregoing solution uses arrays of beamsplitters and polarizing beam splitters and arrays of half wave plates to provide a more compact configuration. However, even arrays of this type are difficult and expensive to manufacture.

### SUMMARY OF THE INVENTION

Thus, it is desirable to provide a polarization apparatus and method that is highly efficient and that can be made very compact. The method of the present invention recovers the unwanted polarized light using just a few holographic optical elements that are extremely compact and which can be replicated using standard holographic recording procedures. Moreover, these holographic elements are switchable. Thus, the present invention is both efficient and offers a relatively low cost solution.

According to the present invention, there is provided an optical polarization device. The optical polarization device includes at least two holographic optical devices. A first holographic optical device is disposed to receive light composed of a first and second component. The two components are each linearly polarized and have respective polarization directions that are mutually perpendicular. The first holographic optical device is operative to diffract the first component while allowing the second component to pass through the first holographic device substantially undiffracted. The optical polarization device further includes a second holographic optical device that has at least one first diffracting region, and at least one second diffracting region. The second holographic device is disposed such that its first diffracting region(s) is (are) positioned to receive the diffracted first component of the light from the first holographic optical device while its second diffracting region(s) is (are) positioned to receive the second component of the light from the first holographic optical device. The first diffracting region(s) is (are) operative to diffract the diffracted first component in a desired output direction. The second diffracting region(s) is (are) operative to diffract the second component from the first holographic device in the desired output direction, and to rotate the polarization direction of the second components to be parallel to the polarization direction of the first an second components.

The first component of the light as received by the first holographic device is a p-polarized component thereof, and the second component of the light as received by the first holographic device is as-polarized component thereof. The polarization rotation by the optical device. Rotation of the polarization direction is accomplished by form birefringence of the fringes.

In one embodiment, the first and second regions of the second holographic optical device are in the form of alternating bands across that device.

The second holographic optical device can be implemented as a first holographic optical element containing said at least one first region and a second holographic optical element containing the at least one second region, with the first and second holographic optical elements being disposed sequentially along the path of the light.

In another embodiment, the second optical polarization device can further include a collimator operative to collimate the randomly polarized light. The collimator can comprise a lens or an array of lenses or microlenses disposed optically between the first holographic optical device and the light source. Alternatively, the collimator can be formed by a holographic diffraction device, which can in turn be incorporated into the first holographic optical device.

The first and second holographic optical devices can each comprise a stack of holographic diffraction elements, each of which is operative to act upon a respective wavelength band of the source light. For example, the first and second holographic optical devices can each consist of three stacked holographic diffraction elements which act upon red, green and blue wavelength bands, respectively.

Each of the holographic diffraction elements can be switchable between an active, diffracting condition and an inactive, non-diffracting condition. A control can be provided which is operative to switch the holographic diffraction devices or elements sequentially into and out of their active conditions.

### BRIEF DESCRIPTION OF THE DRAWINGS

The present invention may be better understood, and its numerous objectives, features and advantages made apparent to those skilled in the art by referencing the accompanying drawings. The use of the same reference number throughout the several figures designates a like or similar element.

FIG. 1 is a schematic side view of a first embodiment of an optical polarization device according to the present invention.

FIGS. 2 is a schematic side view of a second embodiment of an optical polarization device employing a collimator device according to the present invention

FIG. 3 is a schematic side view of a third embodiment of an optical polarization device employing a holographic device having two layers, each providing alternating regions of diffractive and optically neutral regions.

FIG. 4 is a schematic side view of a third embodiment of an optical polarization device employing switchable holographic devices each designed to diffract one of three wavelength bands of light.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed. On the contrary, the intention is to cover all modifications, equivalents and alternatives falling within the spirit and scope of the present invention as defined by the appended claims.

### DETAILED DESCRIPTION

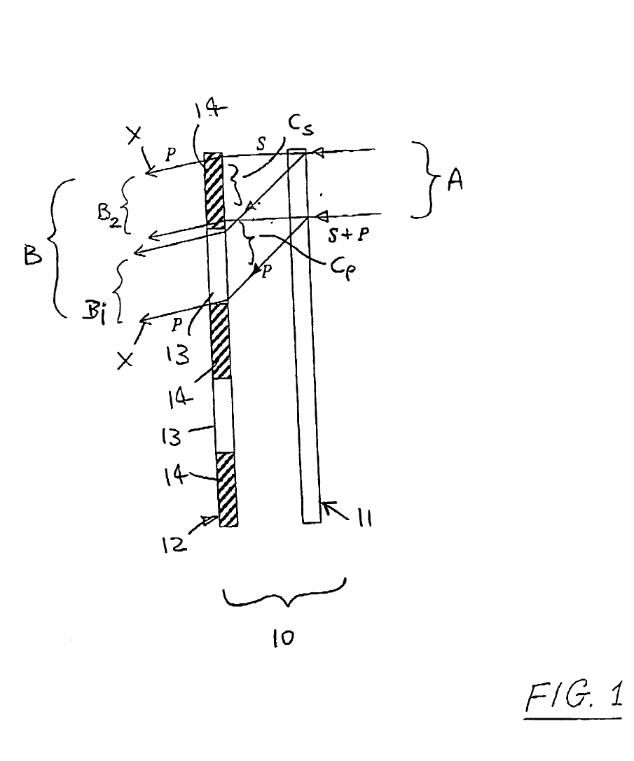

With reference to FIGS. 1-4, a detailed description of the present invention is presented. As a matter of introduction, the embodiments of the optical polarization device of the present invention employ one or more holographic diffraction elements. These elements can be fixed in their diffractive state, or they can be switched from an active state in which they selectively diffract light of a predetermined band of wavelengths incident upon their surfaces, to an inactive state during which they pass the incident light with no diffractive effect on the light passing through them.

In each of the embodiments disclosed, these holographic optical diffraction devices are essentially holograms that have been pre-recorded into a medium. The recording medium is typically a polymer-dispersed liquid crystal mixture that undergoes phase separation during the hologram recording process, creating fringes comprising regions densely populated by liquid crystal micro-droplets interspersed with regions of clear polymer. They are preferably volume holograms, also known as thick or Bragg holograms, that offer high diffraction efficiencies for incident beams whose wavelengths are close to the theoretical wavelength satisfying the Bragg diffraction condition, and which are within a few degrees of the theoretical angle which also satisfies the Bragg diffraction condition.

When an electric field is applied to the hologram by way of electrodes, the natural orientation of the liquid crystal droplets is changed, causing the refractive index modulation of the fringes to reduce and the hologram diffraction efficiency to drop to a very low level. This effectively erases the hologram for as long as the electric field is maintained. In this state, the inactive state of the device, the light incident on the surface of the device passes through the device with virtually no diffraction of the light. Once the electric field is removed, the hologram re-establishes itself. It is possible to achieve very fast switching rates for these devices, typically with a switching time of less than 150 microseconds, and perhaps as low as a few microseconds.

For more information regarding the manufacturing of such holographic devices, please see pending U.S. patent application Ser. No. 09/478,150 filed Jan. 5, 2000 and entitled “Optical Filter Employing Holographic Optical Elements and Imaging System Incorporating the Optical Filter,” which is incorporated herein in its entirety by this reference.

Referring first to FIG. 1, a preferred embodiment of the optical polarization device is shown therein and referenced generally as 10. The optical polarization device 10 is adapted to receive a beam A of randomly-polarized light and to re-emit this light as a beam of plane-polarized light B in a predetermined output direction, as indicated by arrows X. The randomly-polarized light in the beam A consists essentially of a first plane-polarized (“p”) component the electric field vector of which lies in the plane of incidence of the beam A, and a second plane-polarized (“s”) component the electric field vector of which is perpendicular to the plane of incidence of the beam A. It will be obvious to one of ordinary skill that the polarization direction of the p-polarized component is perpendicular to the polarization direction of the s-polarized component. In the embodiment illustrated by FIG. 1, the light of output beam B is composed wholly of p-polarized light, but will be clear that for an alternative embodiment the output beam B can be composed wholly of s-polarized light.

The embodiment of the optical polarization device 10 depicted in FIG. 1 comprises generally a first holographic optical device 11 upon which the randomly-polarized beam A is incident, and which is optically disposed between beam A and a second holographic optical device 12. The device 12 is composed of a plurality of first regions 13 and a plurality of second regions 14, formed as alternating bands across the width of the device 12. As was previously discussed, the device 11 and the regions 13 and 14 of the device 12 each consist essentially of a transmission hologram the fringes of which act to diffract light incident thereon. However, these holograms are of a type that is sensitive to the polarization state of the light incident thereon. More particularly, the diffraction efficiency of the holograms for p-polarized light is significantly greater than that for s-polarized light, as s-polarized light tends to pass through the holograms substantially undiffracted. This is a typical characteristic of holograms that are recorded in a polymer-dispersed liquid crystal material.

When the randomly-polarized light in the beam A is incident upon the device 11, the p-polarized component of that light is diffracted by the holographic fringes and emerges at an angle as a p-polarized beam C_{P}. The beam C_{P} is then incident upon one of the first regions 13 of the device 12, which acts diffractively to deflect the beam into the output direction X but without affecting the polarization state of the light in the beam C₁. As a result, a p-polarized beam B₁ is emitted in the output direction X from the region 13.

In contrast, the s-polarized component of beam A is not diffracted by the device 11 and consequently passes straight through the latter to emerge as an s-polarized beam Cs. This beam then becomes incident upon one of the second regions 14 of the device 12. The holographic fringes in that region 14 are designed to diffract the light into the output direction X while simultaneously rotating its polarization direction by 90° in the manner of a half-wave plate. As a result, a p-polarized beam B₂ is also emitted from device 12 in the output direction X from the region 14. In this way unwanted polarized light is recovered, making the present invention very efficient compared to prior art techniques.

As illustrated in FIG. 1, light from the beam A that passes through device 11 is shown for the sake of simplicity as being acted upon by only one of the regions 13 and one of the regions 14 of the device 12. Those of ordinary skill in the art will recognize that the other regions 13 and 14 will act analogously on the light, such that each of those regions produces its own p-polarized beam in the output direction X, and these beams combine to form the aforementioned output beam B.

The mechanism by which the holographic fringes in the regions 14 to rotate the polarization direction of the light, is form birefringence. The basic theory of this is explained in Born and Wolf “Principles of Optics” Chapter 14, page 705 (Pergamon Press fifth edition 1975), according to which form birefringence requires ordered arrangements oil similar, optically isotropic particles that are large compared with the dimensions of molecules, but small compared with the wavelength of light. In the case of a Bragg hologram, this is equivalent to saying that the Bragg grating pitch must be smaller than the wavelength of the light being used. Under these circumstances, the amount by which the polarization vector rotates is proportional to the thickness of the hologram layer.

In the embodiment of FIG. 1, the output beam B is composed wholly of p-polarized light. However, by designing the holographic fringes of the device 12 such that the regions 13 (rather than the regions 14) act to rotate the polarization direction of light incident thereon, it is possible to arrange for the output beam B to be composed wholly of s-polarized light instead.

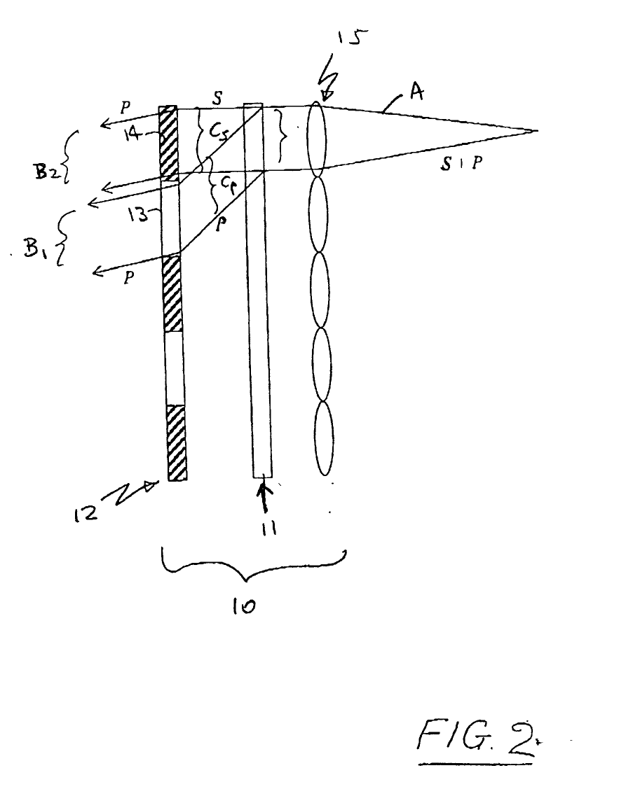

FIG. 2 illustrates a second preferred embodiment of the optical polarization device 10, which is generally similar to that described above with reference to FIG. 1 and accordingly similar parts have been accorded the same reference numerals. In this embodiment, however, the device also includes a collimating device 15 that is positioned optically in front of the device 11 and which is operative to collimate the incident beam A, thereby providing uniform illumination of the devices 11 and 12 when the beam A is not otherwise perfectly collimated. In the embodiment of FIG. 2, the collimating device 15 is composed of an array of lenses or microlenses. However, it can alternatively take the form of a holographic optical device having holographic fringes that are designed to diffract light in the manner of a lens or an array of lenses or microlenses. Such a holographic optical device can either be provided as a separate component, or can be incorporated into the construction of the holographic optical device 11.

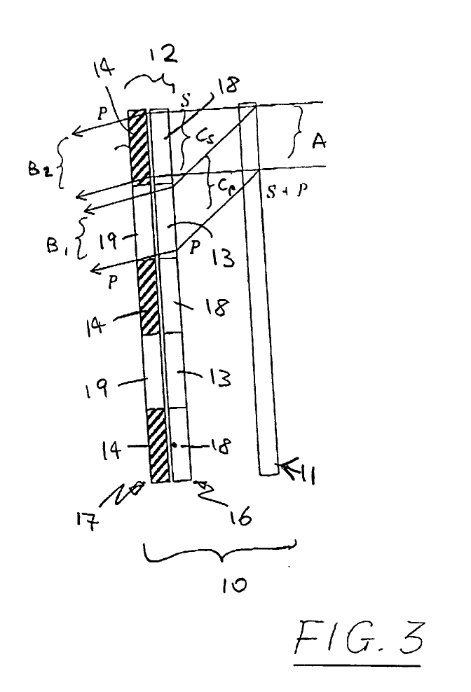

In the above-described embodiment of FIG. 2, the holographic optical device 12 comprises two different sets of holographic fringes (i.e. the fringes that comprise the regions 13 and 14, respectively) recorded in a single layer. This can be achieved by recording the holograms in two stages using suitable exposure masks. FIG. 3 illustrates a third embodiment of the optical polarization device 10 in which the two sets of holograms for regions 13 and 14 are recorded in separate layers. More particularly, the holographic optical device 12 is now composed of two separate holographic diffraction elements 16 and 17, which are disposed one after the other along the optical path. Element 16 contains the aforesaid regions 13 alternating with optically neutral regions 18, while element 17 contains the aforesaid regions 14 alternating with optically neutral regions 19. The elements 16 and 17 are disposed relative to each other such that the optically neutral regions 18 of the element 16 align with the regions 14 of the element 17, and the regions 13 of the element 16 align with the optically neutral regions 19 of the element 17.

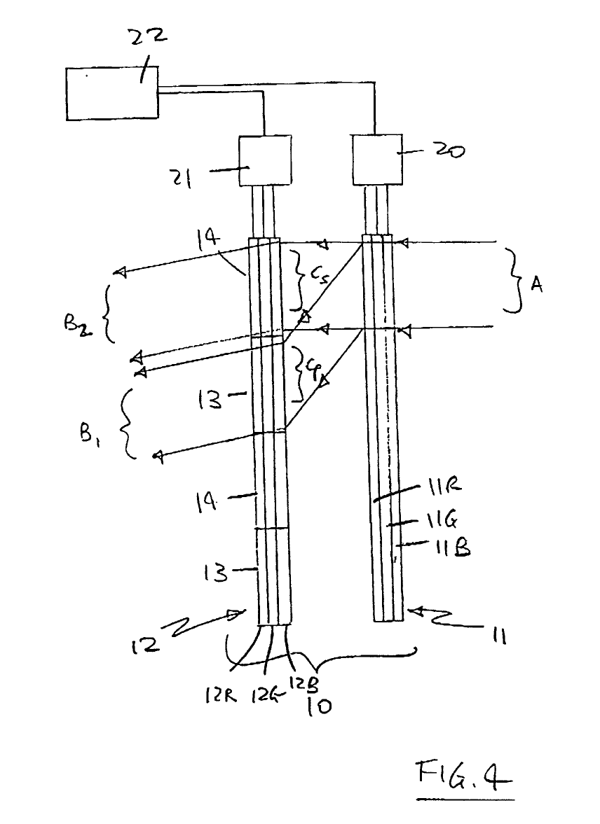

In the embodiments described above, it has been assumed that the light in the incident beam A is substantially monochromatic and that the holographic fringes of the devices 11 and 12 are fixed and designed to act on that specific wavelength band alone. FIG. 4 illustrates a fourth embodiment of the optical polarization device 10 that is suitable for use with polychromatic light. More specifically, the holographic optical device 11 now comprises a stack of holographic diffraction elements, each of which is designed to act upon a respective wavelength band of light. In the embodiment shown, three such elements 11R, 11G and 11B are provided and are designed to act respectively on wavelength bands in the red, green and blue regions of the visible spectrum.

Each of the elements 11R, 11G and 11B essentially comprises a hologram recorded in a medium that is sandwiched between a pair of electrodes. Under normal circumstances (i.e. no voltage across the electrodes), the holographic fringes act to diffract light of the appropriate wavelength band. However, when an electric field is applied by way of the electrodes, the hologram is effectively erased so long as the voltage across the electrodes remains and diffraction will not take place. Thus, by controlling the electric field applied to the electrodes, each element can be switched between an active, diffracting condition and an inactive, non-diffracting condition. Such switching is performed by means of a control 20, which operates such that when any one of the elements 11R, 11G and 11B is activated, the other two elements are de-activated. Thus, at any given time, the overall device 11 acts only on red wavelengths, green wavelengths or blue wavelengths, depending upon which of the three control lines is active.

The holographic optical device 12 is similarly composed of a stack of three holographic diffraction elements 12R, 12G and 12B which act respectively on red, green and blue wavelength bands. These elements are also switchable between an active, diffracting condition and an inactive, non-diffracting condition, with such switching being performed by means of a control 21. As before, the control 21 is arranged such that when any one of the elements 12R, 12G and 12B is activated, the other elements are de-activated, so that at any given time the overall device 12 acts only on red wavelengths, green wavelengths or blue wavelengths.

A master control circuit 22 is connected to the two control circuits 20 and 21. The former causes-the latter to operate in synchronism, i.e. such that the “red” elements 11R and 12R are activated simultaneously, and so on. In this way, the whole device 10 at any given time acts only on red wavelengths, green wavelengths or blue wavelengths at any given time. The control circuit 22 also causes the control circuits 20 and 21 to activate the elements of each device 11 and 12 in cyclic succession, so that the overall device 10 acts sequentially and repeatedly on red, green and blue wavelengths. By performing this operation exceptionally rapidly, the cycling between red, green and blue wavelengths can be performed in less than the eye integration time, so the overall light emitted by the device 10 is seen as effectively comprising a combination of the red, green and blue wavelength bands, i.e. as white light.

To facilitate switching of the holographic diffraction elements between their active and inactive conditions, as previously discussed, the recording medium is typically a polymer-dispersed liquid crystal mixture which undergoes phase separation during the hologram recording process creating fringes that are regions densely populated by liquid crystal micro-droplets interspersed with regions of clear polymer. The aforesaid electrodes are deposited on opposed surfaces of a substrate which is used to encapsulate the holograms and, when an electric field is applied to the hologram by way of these electrodes, the natural orientation of the liquid crystal droplets is changed, causing the refractive index modulation of the fringes to decrease and the hologram diffraction efficiency can drop to a very low level, effectively erasing the hologram. As previously discussed, it is possible to achieve very fast switching rates, typically with a switching time of less than 150 microseconds, and perhaps as low as a few microseconds.

The substrate can be composed of glass, plastics or a composite material, which can be flexible or rigid and flat or curved. The electrodes can be composed of a transparent conducting material, such as ITO or electrically-conducting polymers, and can be provided with anti-reflection coatings. It is also possible for the switching circuitry for the electrodes to be deposited on the substrate as well. Although the holographic diffraction elements 11R 11G, 11B, 12R, 12G and 12B are described above as being switchable, it is possible to use non-switchable elements instead. In this case, reliance would be placed on the wavelength selectivity of the Bragg holograms to prevent cross-talk between the various wavelength bands.

Whereas the invention has been described in relation to what are presently considered to be the most practical and preferred embodiments, it is to be understood that the invention is not limited to the disclosed arrangements but rather is intended to cover various modifications and equivalent constructions included within the spirit and scope of the invention. For example, it is possible to arrange for the holographic diffraction devices to operate with wavelengths other than those of red, green and blue light, and indeed more or less than three such devices can be provided. Also, instead of being activated individually, it is possible to arrange for the holographic diffraction devices to be activated in selected combinations. For example, by activating the “red” and “green” devices together, the overall device can be used to retro-reflect yellow light. It is also possible to use as the incident light a combination of separate monochromatic light sources (e.g. LED's or lasers) instead of a single white light source.

What is claimed is:

1. An optical polarization apparatus comprising:
a first holographic optical device disposed to receive randomly polarized light composed of a first and second component, said first optical device operative to diffract the first component while allowing the second component to pass through said first optical device substantially undiffracted;
a second holographic optical device comprising at least one first diffracting region, and at least one second diffracting region, wherein:
said second holographic device is disposed such that said at least one first diffracting region is positioned to receive the diffracted first component from said first optical device and such that said at least one second diffracting area is positioned to receive said second component of the light from said first optical device;
wherein said at least one first and second diffracting areas diffract the first and second components to produce an output beam having a desired output direction; and
wherein said at least one second diffracting area rotates the polarization direction of the second component to substantially equal that of the first component.

2. The optical polarization apparatus of claim 1 wherein said first and second holographic optical devices comprise one or more holographic elements, and wherein each of said one or more elements comprises a holographic recording medium that records a hologram, wherein the holographic recording medium comprises:
a monomer dipentaerythritol hydroxypentaacrylate;
a liquid crystal;
a cross-linking monomer;
a coinitiator; and
a photoinitiator dye.

3. The optical polarization apparatus of claim 1 wherein said first and second holographic optical devices comprise one or more holographic elements, each said one or more holographic elements comprises a hologram made by exposing an interference pattern inside a polymer-dispersed liquid crystal material, the polymer-dispersed liquid crystal material comprising, before exposure:
(a) a polymerizable monomer;
(b) a liquid crystal;
(c) a cross-linking monomer;
(d) a coinitiator; and
(e) a photoinitiator dye.

4. The optical polarization apparatus of claim 1 wherein the first component of the light received by said first optical device is p-polarized light, and the second component is s-polarized light.

5. The optical polarization apparatus of claim 1 wherein said at least one second diffracting region rotates the polarization direction of the second component by means of form refringence.

6. The optical polarization apparatus of claim 1 wherein said first and second holographic optical devices comprise stacked holographic elements, each of said elements operative to diffract a different one red, green and blue visible light, respectively.

7. The optical polarization apparatus of claim 1 further comprising a collimator disposed between the light and said first holographic optical device.

8. The optical polarization apparatus of claim 7 wherein said collimator is formed integrally with said first holographic optical device as a holographic optical element.

9. The optical polarization apparatus of claim 1 wherein the at least one first and second diffraction regions of said second holographic optical device reside in the same holographic element.

10. The optical polarization apparatus of claim 1 wherein the at least one first and second diffracting regions of said second holographic optical device reside in first and second holographic elements.

11. The optical polarization apparatus of claim 10 wherein:
said first holographic element comprises alternating regions of the at least one first diffracting region and at least one optically neutral region;
said second holographic element comprises alternating regions of the at least one second diffracting region and at least one optically neutral region; and
wherein the at least one optically neutral region of said first holographic element is aligned with the at least one second diffracting region of said second holographic element, and the at least one optically neutral region of said second holographic elements is aligned with the at least one first diffraction region of the first holographic element.

12. The optical polarization apparatus of claim 1 wherein the output beam is substantially p-polarized light.

13. The optical polarization apparatus of claim 1 wherein the output beam is substantially s-polarized light and wherein said at least one first diffracting area rotates the polarization direction of the second component to substantially equal that of the first component.

14. The optical polarization apparatus of claim 1 wherein the output beam is substantially s-polarized light.

15. The optical polarization apparatus of claim 6 wherein each of said stacked holographic layers of said first and second holographic optical devices is independently coupled to a control voltage, and wherein said holographic layers are active and diffract their associated wavelength band when no control voltage is applied and inactive and provide no diffraction to any wavelength band when a control voltage is applied.

16. The optical polarization apparatus of claim 15 wherein the control voltages for said first holographic optical device are controlled by a first control circuit such that only one holographic element of said first holographic optical device is active at any given time, and wherein the control voltages for said second holographic optical device are controlled by a second control circuit such that only one holographic layer of said second holographic optical device is active at any given time.

17. The optical polarization apparatus of claim 16 wherein said first and said second control circuits are coupled to a common third control circuit, said third control circuit ensuring that the holographic elements of said first and second holographic optical devices that diffract the same color are always active together at the same time.

18. The optical polarization apparatus of claim 7 wherein said collimator comprises a lens.

19. The optical polarization apparatus of claim 7 wherein said collimator comprises an array of lenses.
